(19) United States
(12) Patent Application Publication
(10) Pub. No.: US 2020/0026123 A1
(43) Pub. Date: Jan. 23, 2020

(54) POLARIZING FILM WITH ADDED ADHESIVE LAYER, POLARIZING FILM WITH ADDED ADHESIVE LAYER FOR IN-CELL LIQUID CRYSTAL PANEL, IN-CELL LIQUID CRYSTAL PANEL, AND LIQUID CRYSTAL DISPLAY DEVICE

(71) Applicant: NITTO DENKO CORPORATION, Ibaraki-shi, Osaka (JP)

(72) Inventors: Masakuni Fujita, Ibaraki-shi (JP); Yusuke Toyama, Ibaraki-shi (JP)

(73) Assignee: NITTO DENKO CORPORATION, Ibaraki-shi, Osaka (JP)

(21) Appl. No.: 16/497,903

(22) PCT Filed: Mar. 28, 2018
(86) PCT No.: PCT/JP2018/012630

§ 371 Date: Sep. 26, 2019

(30) Foreign Application Priority Data
Mar. 28, 2017 (JP) 2017-064008

(51) Int. Cl. G02F 1/1335; G02F 1/1333; G02F 1/1337

(52) U.S. Cl. CPC G02F 1/133528; G02F 1/13338; G02F 1/133308; G02F 2001/133311; G02F 2001/133334; G02F 2001/133738; G02F 2001/133331; G02F 1/1337

(57) ABSTRACT

The present invention provides a pressure-sensitive adhesive attached polarizing film for realizing an in-cell type liquid crystal panel which can satisfy a stable antistatic function and touch sensor sensitivity and has excellent heat resistance. This pressure-sensitive adhesive attached polarizing film is provided with a pressure-sensitive adhesive layer and a polarizing film, and is characterized in that: the polarizing film comprises at least a polarizer and a transparent protective film; at least the polarizing film, an anchor layer, and the pressure-sensitive adhesive layer are provided in this order from a viewing side; the anchor layer includes a conductive polymer; the surface resistance value of the anchor layer is 1.0×10⁸ to 1.0×10¹¹Ω/□; and the moisture permeability of the transparent protective film at 40° C.×92% RK is 10 g/(m²·24 h) or more.

### TECHNICAL FIELD

The present invention relates to a pressure-sensitive adhesive layer attached polarizing film; a pressure-sensitive adhesive layer attached polarizing film for an in-cell type liquid crystal panel; an in-cell type liquid crystal cell having a touch sensing function incorporated inside the liquid crystal cell; and an in-cell type liquid crystal panel comprising a pressure-sensitive adhesive layer attached polarizing film on the viewing side of the in-cell type liquid crystal cell. Furthermore, the present invention relates to a liquid crystal display device using the liquid crystal panel. The liquid crystal display device provided with a touch sensing function using the in-cell type liquid crystal panel of the present invention can be used as various input display devices such as mobile apparatuses.

### BACKGROUND ART

Generally, in liquid crystal display devices, polarizing films are bonded to both sides of a liquid crystal cell with a pressure-sensitive adhesive layer interposed therebetween from the viewpoint of image forming system. In addition, ones that mount a touch panel on a display screen of a liquid crystal display device have been put to practical use. As the touch panel, there are various methods such as an electrostatic capacitance type, a resistive film type, an optical type, an ultrasonic type, an electromagnetic induction type and the like, but an electrostatic capacitance type has been increasingly adopted. In recent years, a liquid crystal display device provided with a touch sensing function that incorporates an electrostatic capacitance sensor as a touch sensor unit has been used.

On the one hand, at the time of manufacturing a liquid crystal display device, when bonding the pressure-sensitive adhesive layer attached polarizing film to a liquid crystal cell, a release film is peeled from the pressure-sensitive adhesive layer of the pressure-sensitive adhesive layer attached polarizing film, and static electricity is generated by such peeling. Static electricity is also generated when a surface protective film of the polarizing film stuck to the liquid crystal cell is peeled off or when a surface protective film of the cover window is peeled off. The static electricity generated in this way affects the alignment of the liquid crystal layer inside the liquid crystal display device and causes detects. Generation of static electricity can be suppressed, for example, by forming an antistatic layer on the outer surface of the polarizing film.

On the other hand, the electrostatic capacitance sensor in the liquid crystal display device provided with a touch sensing function detects a weak electrostatic capacitance formed by a transparent electrode pattern and the finger when the user's finger approaches the surface. In the case where a conductive layer such as an antistatic layer is provided between the transparent electrode pattern and the user's finger, the electric field between a driving electrode and a sensor electrode ie disturbed, the sensor electrode capacitance becomes unstable and the touch panel sensitivity decreases, causing malfunction. In a liquid crystal display device provided with a touch sensing function, it is required to suppress the occurrence of static electricity and suppress the malfunction of the capacitance sensor. For example, in order to reduce the occurrence of display defects and malfunctions in a liquid crystal display device provided with a touch sensing function for the purpose of solving the above-mentioned problems, it has been proposed to dispose a polarizing film comprising an antistatic layer with a surface resistance value of from 1.0×10⁹ to 1.0×10¹¹Ω/□ on the viewing side of the liquid crystal layer (Patent Document 1).

### PRIOR ART DOCUMENT

### Patent Document

Patent Document 1: JP-A-2013-105154

### SUMMARY OF THE INVENTION

### Problems to be Solved by the Invention

According to the polarizing film comprising an antistatic layer described in Patent Document 1, generation of static electricity can be suppressed to some extent. However, in Patent Document 1, since the location of the antistatic layer is farther than the position of the liquid crystal cell causing display failure due to static electricity, this case is not effective as compared with the case where the pressure-sensitive adhesive layer in contact with the liquid crystal cell is provided with the antistatic function. Further, it has been found that the in-cell type liquid crystal cell is more easily charged than a so-called on-cell liquid crystal cell comprising a sensor electrode on a transparent substrate of the liquid crystal cell described in Patent Document 1.

In addition, the pressure-sensitive adhesive layer to which an antistatic function is imparted is more effective for suppressing generation of static electricity and preventing electrostatic unevenness than the antistatic layer provided on the polarizing film. However, it was found that when the conductive function of the pressure-sensitive adhesive layer is enhanced with importance placed on the antistatic function of the pressure-sensitive adhesive layer, the touch sensor sensitivity is lowered. In particular, it was found that the touch sensor sensitivity is lowered in the liquid crystal display device provided with a touch sensing function using the in-cell type liquid crystal cell. Further, it was found that the antistatic agent blended in the pressure-sensitive adhesive layer for enhancing the conductivity function segregates at the interface with the polarizing film or migrates into the polarizing film in a humidified environment (after a humidification reliability test), so that the surface resistance value of the pressure-sensitive adhesive layer becomes large, resulting in a significant reduction of antistatic function. It was found that such a variation in the surface resistance values on the pressure-sensitive adhesive layer is a cause of generation of electrostatic unevenness as well as occurrence of malfunction of the liquid crystal display device provided with a touch sensing function.

In addition, in the liquid crystal display device and the like, it is indispensable to dispose polarizers on both sides of the liquid crystal cell from the image forming system, and generally, a polarizing film is attached thereto. As the polarizing film, those comprising a transparent protective film on one side or both sides of the polarizer are used. As the transparent protective film, for example, a cellulose-based resin film using triacetyl cellulose or the like is used. Further, as the polarizer, an iodine-based polarizer having a structure in which, for example, iodine is adsorbed to polyvinyl alcchci and is stretched is widely used because such an iodine based polarizer has high transmittance and high polarization degree. However, such a polarizer tends to shrink and expand due to moisture and the like. A polarizing film using a transparent protective film having high moisture permeability like the cellulose-based resin film has a problem such that the durability in a humidified environment is lowered, resulting in a tendency to decrease the degree of polarization.

Therefore, an object of the present invention is to provide a pressure-sensitive adhesive layer attached polarizing film, an in-cell type liquid crystal cell and a pressure-sensitive adhesive layer attached polarizing film for an in-cell type liquid crystal panel applied to the viewing side thereof, and an in-cell type liquid crystal panel comprising the pressure-sensitive adhesive layer attached polarizing film, which can satisfy a stable antistatic function and touch sensor sensitivity even in a humidified environment (after a humidification reliability test) and which is also excellent in heating durability. Another object of the present invention is to provide a liquid crystal display device using the in-cell type liquid crystal panel.

### Means for Solving the Problems

As a result of intensive studies to solve the above problems, the present inventors have found that it is possible to solve the above problems by the following pressure sensitive adhesive layer attached polarizing film, pressure sensitive adhesive layer attached polarizing film for an in-cell type liquid crystal panel, and in-cell type liquid crystal panel, and the present invention has been completed based on these findings.

That is, the pressure-sensitive adhesive layer attached polarizing film of the present invention comprises a pressure-sensitive adhesive layer and a polarizing film, and is characterized in that:

the polarizing film comprises at least a polarizer and a transparent protective film,

at least the polarizing film, an anchor layer, and the pressure-sensitive adhesive layer are provided in this order from a viewing side,

the anchor layer includes a conductive polymer,

a surface resistance value of the anchor layer is from 1.0×10⁸ to 1.0×10¹¹Ω/□, and

a moisture permeability of the transparent protective film at 40° C.×92% RH is 10 g/(m²·24 h) or more.

In the pressure-sensitive adhesive layer attached polarizing film of the present invention, it is preferable that a surface resistance value on a side of the pressure-sensitive adhesive layer when peeling a separator immediately after producing the pressure-sensitive adhesive layer attached polarizing film in a state where the pressure-sensitive adhesive layer is provided with the separator is from 1.0×10⁸ to 2.0×10¹²Ω/□

In the pressure-sensitive adhesive layer attached polarizing film of the present invention, it is preferable that the pressure-sensitive adhesive layer includes an antistatic agent and has a surface resistance value of from 1.0×10⁸ to 5.0×10¹¹Ω/□.

Further, the pressure-sensitive adhesive layer attached polarizing film of the present invention is a pressure-sensitive adhesive layer attached polarizing film for an in-cell type liquid crystal panel, which comprises an in-cell type liquid crystal cell that is provided with a liquid crystal layer comprising liquid crystal molecules which are homogeneously aligned in the absence of an electric field, a first transparent substrate and a second transparent substrate sandwiching the liquid crystal layer on both sides, and a touch sensing electrode unit related to a touch sensor and touch-driven functions disposed between the first transparent substrate and the second transparent substrate, and is characterized by being disposed on the viewing side of the in-cell type liquid crystal cell, wherein:

the pressure-sensitive adhesive layer of the pressure-sensitive adhesive layer attached polarizing film is disposed between the polarizing film of the pressure-sensitive adhesive layer attached polarizing film and the in-cell type liquid crystal cell,

the polarizing film comprises at least a polarizer and a transparent protective film,

at least the polarizing film, an anchor layer, and the pressure-sensitive adhesive layer are provided in this order from the viewing side,

the anchor layer includes a conductive polymer,

a surface resistance value of the anchor layer is from 1.0×10⁸ to 1.0×10¹¹Ω/□, and

a moisture permeability of the transparent protective film at 40° C.×92% RH is 10 g/(m²·24 h) or more.

In the pressure-sensitive adhesive layer attached polarizing film for an in-cell type liquid crystal panel according to the present invention, it is preferable that a surface resistance value on the side of the pressure-sensitive adhesive layer is from 1.0×10⁸ to 2.0×10¹²Ω/□ when peeling a separator immediately after producing the pressure-sensitive adhesive layer attached polarizing film in a state where the pressure-sensitive adhesive layer is provided with the separator.

In the pressure-sensitive adhesive layer attached polarizing film for an in-cell type liquid crystal panel according to the present invention, it is preferable that the pressure-sensitive adhesive layer includes an antistatic agent and has a surface resistance value of from 1.0×10⁸ to 5.0×10¹¹Ω/□.

Further, the in-cell type liquid crystal panel of the present invention has:

an in-cell type liquid crystal cell comprising a liquid crystal layer containing liquid crystal molecules which are homogeneously aligned in the absence of an electric field, a first transparent substrate and a second transparent substrate sandwiching the liquid crystal layer on both sides, and a touch sensing electrode unit related to a touch sensor and touch-driven functions disposed between the first transparent substrate and the second transparent substrate; and

a first polarizing film disposed on a viewing side of the in-cell type liquid crystal cell, a second polarizing film disposed on an opposite side of the viewing side, and a first pressure-sensitive adhesive layer disposed between the first polarizing film and the in-cell type liquid crystal cell; wherein:

the first polarizing film comprises at least a polarizer and a transparent protective film,

at least the first polarizing film, an anchor layer, and the first pressure-sensitive adhesive layer are provided in this order from the viewing side,

the anchor layer includes a conductive polymer,

a surface resistance value of the anchor layer is from 1.0×10⁸ to 1.0×10¹¹Ω/□, and

a moisture permeability of the transparent protective film at 40° C.×92% RH is 10 g/(m²·24 h) or more.

In the in-cell type liquid crystal panel of the present invention, it is preferable that a surface resistance value on the side of the first pressure-sensitive adhesive layer is from 1.0×10⁸ to 2.0×10¹²Ω/□ when peeling a separator immediately after producing the pressure-sensitive adhesive layer attached first polarizing film in a state where the first pressure-sensitive adhesive layer is provided with the separator.

In the in-cell type liquid crystal panel of the present invention, it is preferable that the first pressure-sensitive adhesive layer includes an antistatic agent and has a surface resistance value of from 1.0×10⁸ to 5.0×10¹¹Ω/□.

Further, the liquid crystal display device of the present invention preferably comprises the in-cell type liquid crystal panel,

### Effect of the Invention

The pressure-sensitive adhesive layer attached polarizing film on the viewing side of the in-cell type liquid crystal panel of the present invention includes a conductive polymer in the anchor layer, and the surface resistance value of the anchor layer is controlled within a predetermined range and the transparent protective film constituting the polarizing film has a moisture permeability in a specific range. Thus, the pressure-sensitive adhesive layer attached polarizing film is excellent in heating durability and can satisfy the touch sensor sensitivity while having a stable good antistatic function even in a humidified environment (after a humidification test).

### BRIEF DESCRIPTION OF THE DRAWINGS

FIG. 1 is a cross-sectional view showing an example of a pressure-sensitive adhesive layer attached polarizing film used on the viewing side of the in-cell type liquid crystal panel of the present invention.

FIG. 2 is a cross-sectional view showing an example of the in-cell type liquid crystal panel of the present invention.

FIG. 3 is a cross-sectional view showing an example of the in-cell type liquid crystal panel of the present invention.

FIG. 4 is a cross-sectional view showing an example of the in-cell type liquid crystal panel of the present invention.

FIG. 5 is a cross-sectional view showing an example of the in-cell type liquid crystal panel of the present invention.

FIG. 6 is a cross-sectional view showing an example of the in-cell type liquid crystal panel of the present invention.

### MODE FOR CARRYING OUT THE INVENTION

### <Pressure-Sensitive Adhesive Layer Attached Polarizing Film>

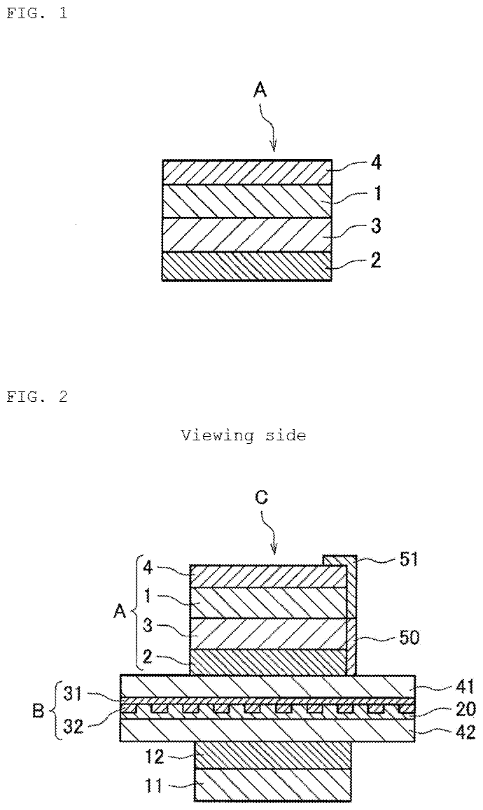

Hereinafter, the present invention will be described with reference to the drawings. As shown in FIG. 1, a pressure-sensitive adhesive layer attached polarizing film A to be used for a viewing side of the in-cell type liquid crystal panel of the present invention has a first polarizing film 1, an anchor layer 3, and a first pressure-sensitive adhesive layer 2 in this order. Further, a surface treatment layer 4 may be provided on the side of the first polarizing film 1 on which the anchor layer 3 is not provided. FIG. 1 illustrates a case where the pressure-sensitive adhesive layer attached polarizing film A of the present invention has the surface treatment layer 4. The pressure-sensitive adhesive layer attached polarizing film A is disposed on a side of a transparent substrate 41 on the viewing side of an in-cell type liquid crystal cell B shown in FIG. 2 via the pressure-sensitive adhesive layer 2. Although not shown in FIG. 1, a separator may be provided in the first pressure-sensitive adhesive layer 2 of the pressure-sensitive adhesive layer attached polarizing film A of the present invention, and a surface protective film may be provided on the first polarizing film 1.

### <First Polarizing Film>

The first polarizing film used in the in-cell type liquid crystal panel of the present invention comprises at least a polarizer and a transparent protective film and is characterized by having at least the first polarizing film, an anchor layer, and the first pressure-sensitive adhesive layer in this order from the viewing side. There are cases where the polarizer is directly laminated on the first pressure-sensitive adhesive layer or laminated on the first pressure-sensitive adhesive layer with the transparent protective film interposed therebetween. In addition, in general, one having the transparent protective film on one side or both sides of the polarizer is used, and in the case where the transparent protective film is provided on one side, such case includes even a case where the transparent protective film is on the viewing side from the polarizer or a case where the transparent protective film is not on the viewing side from the polarizer.

The polarizer is not particularly limited but various kinds of polarizers may be used. Examples of the polarizer include a film obtained by uniaxial stretching after a dichromatic substance, such as iodine and dichroic dye, is adsorbed to a hydrophilic high molecular weight polymer film, such as polyvinyl alcohol-based film, partially formalized polyvinyl alcohol-based film, and ethylene-vinyl acetate copolymer-based partially saponified film, a polyene-based alignment film, such as dehydrated polyvinyl alcohol and dehydrochlorinated polyvinyl chloride, and the like. Among them, a polarizer composed of a polyvinyl alcohol-based film and a dichroic substance such as iodine is suitable. Thickness of these polarizers is not particularly limited but is generally about 80 μm or less.

As a polarizer, a thin polarizer with a thickness of 10 μm or less can be used. From the viewpoint of thinning, the thickness is preferably from 1 to 7 μm. It is preferable that such a thin polarizer has less unevenness in thickness, excellent visibility, and less dimensional change, so it is excellent in durability, and furthermore, the thickness as a polarizing film can be reduced.

The moisture permeability at 40° C.×92% RH of the transparent protective film used in the in-cell type liquid crystal panel of the present invention is characterized by being 10 g/(m²·24 h) or more. The moisture permeability is preferably 20 g/(m²·24 h) or more, more preferably 800 g/(m²·24 h) or more, and the moisture permeability is preferably 1500 g/(m²·24 h) or less, more preferably 1200 g/(m²·24 h) or less. When the moisture permeability is less than 10 g/(m²·24 h), the durability in a heating environment is not sufficient, and there is a possibility that foaming or peeling of the pressure-sensitive adhesive layer may occur, which is not preferable. On the other hand, even when the moisture permeability exceeds 1500 g/(m²·24 h), the durability in a humidified environment is not sufficient, and the decrease in the degree of polarization cannot be sufficiently suppressed.

The material constituting the transparent protective film used in the in-cell type liquid crystal panel of the present invention may be any material as long as it has such a moisture permeability mentioned above, but the thermoplastic resin excellent in, for example, transparency, mechanical strength, thermal stability, moisture barrier properties, isotropy and the like, is used. Specific examples of such thermoplastic resins include cellulose resins (e.g. triacetyl cellulose, etc.), polyester resins, polyether sulfone resins, polysulfone resins polycarbonate resins, polyamide resins, polyimide resins, polyolefin resins, (meth)acrylic resins, cyclic polyolefin resins (norbornene resins), polyarylate resins, polystyrene resins, polyvinyl alcohol resins, and mixtures thereof. The transparent protective film is laminated on one side of the polarizer with an adhesive layer, but on the other side, as a transparent protective film, a thermosetting resin or an ultraviolet curing resin, such as a (meth)acrylic resin, a urethane-based resin, an acrylic urethane-based resin, an epoxy-based resin, and a silicone-based resin, can be used. One or more arbitrary suitable additives may be contained in the transparent protective film. Examples of the additives include ultraviolet absorbers, antioxidants, lubricants, plasticizers, release agents, coloring inhibitors, flame retardants, nucleating agents, antistatic agents, pigments, colorants and the like. The amount of the thermoplastic resin used in the transparent protective film is preferably 50 to 100% by weight, more preferably 50 to 99% by weight, even more preferably 60 to 98% by weight, particularly preferably 70 to 97% by weight. When the content of the thermoplastic resin in the transparent protective film is 50% by weight or less, high transparency and the like originally possessed by the thermoplastic resin may not be sufficiently exhibited.

The thickness of the transparent protective film can be appropriately determined, but generally it is about 1 to 200 μm from the viewpoint of workability such as strength and handling property, thin layer property and the like. In particular, the thickness is in the range of from 1 to 200 μm, particularly preferably in the range of from 1 to 100 μm, more preferably in the range of from 5 to 100 μm, and is even more preferably thin in the range of from 5 to 80 μm.

The adhesive used for bonding the polarizer and the transparent protective film is not particularly limited as long as it is optically transparent, and various types of aqueous type adhesives, solvent type adhesives, hot melt type adhesives, radical curable type adhesives, and cationic curable type adhesives are used. However, an aqueous type adhesive or a radical curable type adhesive is preferable.

### <First Pressure-Sensitive Adhesive Layer>

The first pressure-sensitive adhesive layer (single body) constituting the in-cell type liquid crystal panel of the present invention may include an antistatic agent, and the surface resistance value of the first pressure-sensitive adhesive layer (single body) is preferably 1.0×10⁸ to 5.0×10¹¹Ω/□, more preferably 2.0×10⁸ to 4.0×10¹¹Ω/□, and preferably 4.0×10⁸ to 3.0×10¹¹. The surface resistance value in the range of the first pressure-sensitive adhesive layer is a preferable embodiment from the viewpoints of the antistatic function and touch sensor sensitivity.

The thickness of the first pressure-sensitive adhesive layer is preferably from 5 to 100 μm, more preferably from 5 to 50 μm, still more preferably from 10 to 35 μm, from the viewpoint of ensuring the durability and the contact area with the side conduction structure. With regard to the contact area with the conduction structure, in the case of providing the conduction structure on the side surface of the polarizing film in the in-cell type liquid crystal panel, the thickness of the first pressure-sensitive adhesive layer is controlled within the range, so that the contact area with the conduction structure can be secured to impart an excellent antistatic function, which is preferable.

As the pressure-sensitive adhesive for forming the first pressure-sensitive adhesive layer, various pressure-sensitive adhesives can be used. Examples of the pressure-sensitive adhesives include rubber-based pressure-sensitive adhesives, acrylic pressure-sensitive adhesives, silicone-based pressure-sensitive adhesives, urethane-based pressure-sensitive adhesives, vinyl alkyl ether-based pressure-sensitive adhesives, polyvinylpyrrolidone-based pressure-sensitive adhesives, polyacrylamide-based pressure-sensitive adhesives, cellulose-based pressure. A pressure-sensitive adhesive base polymer is selected depending on the type of the pressure-sensitive adhesives. Among the above-mentioned pressure-sensitive adhesives, an acrylic pressure-sensitive adhesive is preferably used from the viewpoints of excellent optical transparency, suitable pressure-sensitive adhesive properties such as wettability, cohesiveness and adhesiveness, and excellent weather resistance, heat resistance and the like.

The acrylic pressure-sensitive adhesive contains a (meth)acrylic polymer as a base polymer. The (meth)acrylic polymer usually contains, as a monomer unit, an alkyl (meth)acrylate as a main component. Incidentally, (meth)acrylate refers to acrylate and/or methacrylate and the “(meth)” is used in the same meaning in the present specification.

As the alkyl (meth)acrylate constituting the main skeleton of the (meth)acrylic polymer, linear or branched alkyl groups each having 1 to 18 carbon atoms can be exemplified. These can be used alone or in combination. The average number of carbon atoms of these alkyl groups is preferably from 3 to 9.

From the viewpoints of adhesive properties, durability, adjustment of retardation, adjustment of refractive index, and the like, an alkyl (meth)acrylate containing an aromatic ring, such as phenoxyethyl (meth)acrylate and benzyl (meth)acrylate, can be used as a copolymerization monomer.

In addition, it is preferable to use a polar functional group-containing monomer as a copolymerizable monomer in order to suppress an increase in the surface resistance value over time (especially in a humidified environment) and to satisfy durability. The polar functional group-containing monomer contains any one of a carboxyl group, a hydroxyl group, a nitrogen-containing group, and an alkoxy group as a polar functional group in its structure and is also a compound containing a polymerizable unsaturated double bond such as a (meth)acryloyl group and a vinyl group.

In particular, among the polar functional group-containing monomers, hydroxyl group-containing monomers are preferable in order to suppress an increase in the surface resistance value over time (particularly in a humidified environment) or to satisfy the durability. In addition, these monomers can be used singly or in combination thereof.

Specific examples of the carboxyl group-containing monomer include (meth)acrylic acid, carboxyethyl (meth)acrylate, carboxypentyl (meth)acrylate, itaconic acid, maleic acid, fumaric acid, crotonic acid, and the like.

Among the carboxyl group-containing monomers, acrylic acid is preferable from the viewpoints of copolymerizability, cost, and adhesive properties.

Specific examples of the hydroxyl group-containing monomer include hydroxcyalkyl (meth)acrylates (e.g. 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, etc.), (4-hydroxymethylcyclohexyl)-methylacrylate, and the like.

Among the hydroxyl group-containing monomers, 2-hydroxyethyl (meth)acrylate and 4-hydroxybutyl (meth)acrylate are preferable from the viewpoint of compatibility between the temporal stability of the surface resistance value and durability, and 4-hydroxybutyl (meth)acrylate is particularly preferred.

Specific examples of the nitrogen-containing group-containing monomer include a nitrogen-containing heterocyclic compound having a vinyl group, such as N-vinyl-2-pyrrolidone, N-vinylcaprolactam, and N-acryloylmorpholine; dialkyl-substituted (meth)acrylamides such as N,N-dimethyl (meth)acrylamide, N,N-diethyl (meth)acrylamide, N,N-dipropyl acrylamide, N,N-diisopropyl (meth)acrylamide, N,N-dibutyl (meth)acrylamide, N-ethyl-N-methyl (meth)acrylamide, N-methyl-N-propyl (meth)acrylamide, and N-methyl-N-isopropyl (meth)acrylamide; dialkylamino (meth)acrylates such as N,N-dimethylaminomethyl (meth)acrylate, N,N-dimethylaminoethyl (meth)acrylate, N,N-dimethylaminopropyl (meth)acrylate, N,N-dimethylaminoisopropyl (meth)acrylate, N,N-dimeathyaminobutyl (meth)acrylate, N-ethyl-N-methylaminoethyl (meth)acrylate, N-methyl-N-propylaminoethyl (meth)acrylate, N-methyl-N-isopropylaminoethyl (meth)acrylate, and N,N-dibutylaminoethyl (meth)acrylate; N,N-dialkyl-substituted aminopropyl (meth)acrylamides such as N,N-dimethylaminoproyl (meth)acrylamide, N,N-diethylaminoproyl (meth)acrylamide, N,N-dipropylaminoproyl (meth)acrylamide, N,N-diisopropylaminoproyl (meth)acrylamide, N-ethyl-N-methylaminopropyl (meth)acrylamide, N-methyl-N-propylaminopropyl (meth)acrylamide, N-methyl-N-isopropylaminoproyl (meth)acrylamide; and the like.

The nitrogen-containing group-containing monomer is preferable in terms of satisfying durability, and among the nitrogen-containing group-containing monomers, particularly preferred is an N-vinyl group-containing lactam-based monomer among nitrogen-containing heterocyclic compounds having a vinyl group.

Examples of the alkoxy group-containing monomer include 2-methoxyethyl (meth)acrylate, 2-ethoxyethyl (meth)acrylate, 2-propoxyethyl (meth)acrylate, 2-isopropoxyethyl (meth)acrylate, 2-butoxyethyl (meth)acrylate, 2-methoxypropyl (meth)acrylate, 2-ethoxypropyl (meth)acrylate, 2-propoxypropyl (meth)acrylate, 2-isopropoxypropyl (meth)acrylate, 2-butoxypropyl (meth)acrylate, 3-methoxypropyl (meth)acrylate, 3-ethoxypropyl (meth)acrylate, 3-propoxypropyl (meth)acrylate, 3-isopropoxypropyl (meth)acrylate, 3-butoxypropyl (meth)acrylate, 4-methoxybutyl (meth)acrylate, 4-ethoxybutyl (meth)acrylate, 4-propoxybutyl (meth)acrylate, 4-isopropoxybutyl (meth)acrylate, 4-butoxybutyl (meth)acrylate, and the like.

These alkoxy group-containing monomers have a structure in which an atom of the alkyl group in the alkyl (meth)acrylate is substituted with an alkoxy group.

Further, examples of the copolymerizable monomers (copolymerization monomers) other than the above include a silane-based monomer containing a silicon atom. Examples of the silane-based monomer include 3-acryloxypropyl-triethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyl-triethoxysilane, 10-acryloyloxydecyltriethoxysilane, and the like.

As the copolymerizable monomer, it is also possible to use a polyfunctional monomer having two or more unsaturated double bonds of a (meth)acryloyl group, a vinyl group or the like, such as an esterified substance of (meth)acrylic acid and polyalcohol, wherein the esterified substance includes: tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethyl olpropanetri(meth)acrylate, pentaerythritol tri(meth)acrylate, pentaerythritol tetra(meth)acrylate dipentaerythritol penta(meth)acrylate dipentaerythritol hexa(meth)acrylate, and caprolactone-modified dipentaerythritol hexa(meth)acrylate and polyester (meth)acrylate, epoxy (meth)acrylate and urethane (meth)acrylate obtained by adding, as the same functional group as that in the monomer component, two or more unsaturated double bonds of a (meth)acryloyl group, a vinyl group or the like, respectively, to polyester, epoxy and urethane as a backbone.

In addition, an alicyclic structure-containing monomer can be introduced into the (meth)acrylic polymer by copolymerization for the purpose of improving durability and imparting stress relaxation property. The carbon ring having an alicyclic structure in the alicyclic structure-containing monomer may have a saturated structure or may partially have an unsaturated bond. The alicyclic structure may be a monocyclic alicyclic structure or a polycyclic alicyclic structure such as a bicyclic or tricyclic structure. Examples of the alicyclic structure-containing monomer include cyclohexyl (meth)acrylate, dicyclopentanyl (meth)acrylate, adamantyl (meth)acrylate, isobornyl (meth)acrylate, dicyclopentenyl (meth)acrylate, dicyclopentenyloxyethyl (meth)acrylate, and the like. Among them, from the viewpoint of exhibiting more excellent durability, dicyclopentanyl (meth)acrylate, adamantyl (meth)acrylate or isobornyl (meth)acrylate is preferable, and isobornyl (meth)acrylate is particularly preferable.

The (meth)acrylic polymer contains alkyl (meth)acrylate as a main component and the proportion thereof at the weight ratio with respect to all the constituent monomers is preferably 60 to 99% by weight, more preferably 65 to 90% by weight, still more preferably 70 to 85% by weight. By using the alkyl (meth)acrylate as a main component, excellent adhesive properties are achieved, which is preferable.

In the (meth)acrylic polymer, the weight ratio of the copolymerizable monomer with respect to all the constituent monomers is preferably 1 to 40% by weight, more preferably 10 to 35% by weight, still more preferably 15 to 30% by weight.

Among these copolymerizable monomers, the hydroxyl group-containing monomer and the carboxyl group-containing monomer are preferably used from the viewpoints of adhesion property and durability. Further, the hydroxyl group-containing monomer and the carboxyl group-containing monomer can be used in combination. In the case where the pressure-sensitive adhesive composition contains a crosslinking agent, these copolymerizable monomers serve as a reactive site with the crosslinking agent. The hydroxyl group-containing monomer and the carboxyl group-containing monomer are sufficiently reactive with an intermolecular crosslinking agent, so that such a monomer is preferably used to enhance cohesion property and heat resistance of a resulting pressure-sensitive adhesive layer. The hydroxyl group-containing monomer is preferable from the viewpoint of reworkability, and the carboxyl group-containing monomer is preferable from the viewpoint of achieving both durability and reworkability.

In the case of containing the hydroxyl group-containing monomer as the copolymerizable monomer, the content thereof is preferably 0.01 to 10% by weight, more preferably 0.02 to 5% by weight, still more preferably 0.05 to 3% by weight. Further, in the case of containing the carboxyl group-containing monomer as the copolymerizable monomer, the content thereof is preferably 0.01 to 5% by weight, more preferably 0.05 to 3% by weight, still more preferably 0.1 to 2% by weight.

The (meth)acrylic polymer of the present invention usually has a weight average molecular weight in the range of 1,000,000 to 2,500,000. Considering durability, particularly, heat resistance, the weight average molecular weight is preferably from 1,200,000 to 2,000,000. The weight average molecular weight of 1,000,000 or more is preferable from the viewpoint of heat resistance. In addition, when the weight average molecular weight is more than 2,500,000, the pressure-sensitive adhesive tends to be hard, and peeling tends to occur. The weight average molecular weight (Mw)/number average molecular weight (Mn) showing molecular weight distribution is preferably from 1.8 to 10, more preferably from 1.8 to 7, still more preferably from 1.8 to 5. When the molecular weight distribution (Mw/Mn) exceeds 10, such distribution is not preferable in terms of durability. In addition, the weight average molecular weight and the molecular weight distribution (Mw/Mn) are measured by GPC (gel permeation chromatography) and are determined from the value calculated by polystyrene conversion.

As regards production of the (meth)acrylic polymer, it is possible to appropriately select one of conventional production methods such as solution polymerization, bulk polymerization, emulsion polymerization and various radical polymerizations. The resulting (meth)acrylic polymer may be any type of copolymers such as a random copolymer, a block copolymer, and a graft copolymer.

### <Antistatic Agent>

The first pressure-sensitive adhesive layer constituting the in-cell type liquid crystal panel of the present invention preferably includes an antistatic agent. From the viewpoint of the antistatic function, the antistatic agent is preferably an ionic compound containing a fluorine-containing anion. The ionic compound is preferable from the viewpoints of compatibility with the base polymers and transparency of the pressure-sensitive adhesive layer. As the ionic compound, an inorganic cation-anion salt and/or an organic cation-anion salt can be preferably used. In the present invention, the “inorganic cation-anion salt” generally refers to an alkali metal salt formed from an alkali metal cation and an anion, and as the alkali metal salt, an organic salt of an alkali metal and an inorganic salt of an alkali metal can be used. Further, as used in the present invention, the “organic cation-anion salt” means an organic salt, the cation moiety of which is composed of an organic substance, and the anion moiety may be an organic substance or an inorganic substance. The “organic cation-anion salt” is also called an ionic liquid or an ionic solid.

In addition, an ionic compound (inorganic cation-anion salt) containing an inorganic cation when used can suppress a decrease in adhesiveness (an anchoring force) between the anchor layer and the pressure-sensitive adhesive layer and is more preferable as compared to an organic cation-anion salt.

### <Alkali Metal Salt>

As an alkali metal ion which constitutes the cation moiety of an alkali metal salt, each ion of lithium, sodium, and potassium is mentioned. Among these alkali metal ions, lithium ion is preferable.

The anion moiety of the alkali metal salt may be composed of an organic substance or an inorganic substance. Examples of the anion moiety constituting the organic salt include CH₃COO⁻, CF₃COO⁻, CH₃SO₃⁻, CF₃SO₃C⁻, (CF₃SO₂)₃C⁻, C₄F₉SO₃⁻, C₃F₇COO⁻, (CF₃SO₂)(CF₃CO)N⁻, “O₃S(CF₂)₃SO₃”, PF₆⁻, CO₃²⁻, and the following general formulas (1) to (4):

(Cₙ(F₂ₙ₊₁SO₂)₂N⁻ (1):

(wherein n is an integer of from 1 to 10),

CF₂(CₘF₂ₘSO₂)₂N⁻ (2):

(wherein m is an integer of from 1 to 10),

“O₃S(CF₂)ₗSO₃” (3):

(wherein 1 is an integer of from 1 to 10),

(CₚF₂ₚ₊₁SO₂)N⁻(C_{q}F_{2q+1}SO₂) (4):

(wherein p and q are each an integer of from 1 to 10), and (FSO₂)₂N⁻, and the like.
In particular, an anion moiety containing a fluorine atom is preferably used since such a moiety is able to give an ionic compound having a good ion dissociation property. Examples of the anion moiety constituting the inorganic salt to be used include Cl⁻, Br⁻, I⁻, AlCl₄⁻, Al₂Cl₇⁻, BF₄⁻, PF₆⁻, ClO₄⁻, NO₃⁻, AsF₆⁻, SbF₆⁻, NbF₆⁻, TaF₆⁻, (CN)₂N⁻, and the like are used. Among the anions containing a fluorine atom, fluorine-containing imide anions are preferable, and among them, bis(trifluoromethanesulfonyl)imide anion and bis(fluorosulfonyl)imide anion are preferable. In particular, bis(fluorosulfonyl)imide anion is preferable because it can impart excellent antistatic properties by adding a relatively small amount, maintains adhesive properties, and is advantageous for durability under humidification and heating environment.

Specific examples of the alkali metal organic salt include preferably sodium acetate, sodium alginate, sodium lignin sulfonate, sodium toluene sulfonate, LiCF₃SO₃, Li(CF₃SO₂)₂N, Li(CF₃SO₂)₂N, Li(C₄F₉SO₂)₂N, Li(C₄F₉SO₂)₂N, Li(CF₃SO₂)₃C, KO₃S(CF₂)₃SO₃K, and LiO₃S(CF₂)₃SO₃K. Of these, LiCF₃SO₃, Li(CF₃SO₂)₂N, Li(C₂F₅SO₂)₂N, Li(C₄F₉SO₂)₂N, Li(CF₃SO₂)₃C, and the like are preferable, and fluorine-containing lithium imide salts such as Li(CF₃SO₂)₂N, Li(C₂F₅SO₂)₂N, Li(C₄F₉SO₂)₂N, and Li(FSO₂)₂N are more preferable, and bis(trifluoromethanesulfonyl)imide lithium salt and bis(fluorosulfonyl)imide lithium salt are particularly preferable.

Moreover, as an inorganic salt of an alkali metal, there are exemplified lithium perchlorate and lithium iodide.

### <Organic Cation-Anion Salt>

The organic cation-anion salt used in the present invention is composed of a cation component and an anion component, and the cation component is composed of an organic substance. Specific examples of the cation component include a pyridinium cation, a piperidinium cation, a pyrrolidinium cation, a cation having a pyrroline skeleton, a cation having a pyrrole skeleton, an imidazolium cation, a tetrahydropyrimidinium cation, a dihydropyrimidinium cation, a pyrazolium cation, a pyrazolinium cation, a tetraalkylammonium cation, a trialkylsulfonium cation, a tetraalkylphosphonium cation, and the like.

Examples of the anion component to be used include Cl⁻, Br⁻, I⁻, AlCl₄⁻, AlCl₇⁻, BF₄⁻, PF₆⁻, ClO₄⁻, NO₃⁻, CH₃COO⁻, CF₃COO⁻, CH₃SO₃⁻, CF₃SO₃⁻, (CF₃SO₂)₃C⁻, AsF₆, SbF₆⁻, NbF₆⁻, TaF₆⁻, (CN)₂N⁻, C₄F₉SO₃⁻, C₃F₇COO⁻, (CF₃SO₂)(CF₃CO)N⁻, ⁻O₃S(CF₂)₃SO₃⁻, and the following general formulas (1) to (4):

(Cₙ(F₂ₙ₊₁SO₂)₂N⁻ (1):

(wherein n is an integer of from 1 to 10),

CF₂(CₘF₂ₘSO₂)₂N⁻ (2):

(wherein m is an integer of from 1 to 10),

⁻O₃S(CF₂)ₗSO₃⁻ (3):

(wherein 1 is an integer of from 1 to 10),

(CₚF₂ₚ₊₁SO₂)N⁻(C_{q}F_{2q+1}SO₂) (4):

(wherein p and q are each an integer of from 1 to 10), and (FSO₂)₂N⁻, and the like. Among them, an anion component containing a fluorine atom (fluorine-containing anion) is particularly preferably used because an ionic compound having a good ion dissociation property can be obtained. Among the anions containing a fluorine atom, a fluorine-containing imide anion is preferable, and among these, a bis(trifluoromethanesulfonyl)imide anion and a bis(fluorosulfonyl)imide anion are preferable. In particular, the bis(fluorosulfonyl)imide anion is preferable because it can impart excellent antistatic properties by adding a relatively small amount, maintains adhesive properties, and is advantageous for durability in a humidified and heated environment.

In addition to the inorganic cation-anion salt (alkali metal salt) and the organic cation-anion salt, examples of the ionic compound include inorganic salts such as ammonium chloride, aluminum chloride, copper chloride, ferrous chloride, ferric chloride, ammonium sulfate and the like. These ionic compounds can be used singly or in combination of two or more kinds thereof.

Furthermore, as other antistatic agents, for example, materials capable of imparting antistatic properties, such as ionic surfactants, conductive polymers, conductive microparticles and the like, can be mentioned.

Examples of the ionic surfactant include cationic surfactants (for example, quaternary ammonium salt type, phosphonium salt type, sulfonium salt type, etc.), anionic surfactants (carboxylic acid type, sulfonate type, sulfate type, phosphate type, phosphite type, etc.i, amphoteric surfactants (sulfobetaine type, alkylbetan type, alkylimidazolium betaine type, etc. or nonionic surfactants (polyhydric alcohol derivative, β-cyclodextrin inclusion compound, sorbitan fatty acid monoester/diester, polyalkylene oxide derivative, amine oxide, etc.).

Examples of the conductive polymer include polymers of polyaniline type, polythiophene type, polypyrrole type, polyquinoxaline type, and the like, among which polyaniline and polythiophene are preferably used because they tend to be water soluble conductive polymers or water dispersible conductive polymers. Polythiophene is particularly preferable.

As the conductive microparticles, metal oxides such as tin oxide type, antimony oxide type, indium oxide type, zinc oxide type and the like can be listed. Of these, the tin oxide type is preferable. Examples of tin oxide type materials include antimony-doped tin oxide, indium-doped tin oxide, aluminum-doped tin oxide, tungsten-doped tin oxide, titanium oxide-cerium oxide-tin oxide complex, titanium oxide-tin oxide complex and the like, in addition to tin oxide. The average particle diameter of the microparticles is about 1 to 100 nm, preferably 2 to 50 nm,

Further, as the antistatic agents other than those described above, there are exemplified acetylene black, ketjen black, natural graphite, artificial graphite, and titanium black, and a homopolymer of a monomer having an ion conductive group such as cation type (quaternary ammonium salt etc.), amphoteric type (betaine compound etc.), anion type (sulfonic acid salt etc.) or nonionic type (glycerin etc.), or a copolymer of the monomer and another monomer, and an ion conductive polymer having a site derived from an acrylate or a methacrylate having a quaternary ammonium base; and a permanent antistatic agent of a type in which a hydrophilic polymer such as a polyethylene methacrylate copolymer is alloyed to an acrylic resin or the like.

Although the amount of each of the pressure-sensitive adhesive and the antistatic agent used depends on the type of the pressure-sensitive adhesive and the antistatic agent, such amount is controlled such that the surface resistance value on a side of the obtained first pressure-sensitive adhesive layer side is within a range of from 1.0×10⁸ to 2.0×10¹²Ω/□. For example, an antistatic agent (for example, in the case of an ionic compound) is preferably used in a range of from 0.05 to 20 parts by weight with respect to 100 parts by weight of a base polymer (for example, a (meth)acrylic polymer) of a pressure-sensitive adhesive. It is preferable to use the antistatic agent in the range in order to improve antistatic performance. On the other hand, when the amount of the antistatic agent exceeds 20 parts by weight and the pressure-sensitive adhesive layer or the in-cell type liquid crystal panel including the pressure-sensitive adhesive layer is exposed to a humidified environment, problems in appearance such as precipitation and segregation of the antistatic agent and cloudiness, as well as foaming and peeling occurs in a humidified environment. As a result, the durability may not be sufficient, which is not preferable. In addition, there is a possibility that the adhesiveness (an anchoring force) between the anchor layer and the pressure-sensitive adhesive layer may decrease, which is not desirable. Further, the amount of the antistatic agent to be used is preferably 0.1 parts by weight or more, and more preferably 1 part by weight or more. In order to satisfy the durability, the antistatic agent is preferably used in an amount of 18 parts by weight or less, and more preferably 16 parts by weight or less.

The pressure-sensitive adhesive composition for forming the first pressure-sensitive adhesive layer can contain a crosslinking agent corresponding to the base polymer. For example, when a (meth)acrylic polymer is used as the base polymer, an organic crosslinking agent or a polyfunctional metal chelate can be used as the crosslinking agent. Examples of the organic crosslinking agent include isocyanate type crosslinking agents, peroxide type crosslinking agents, epoxy type crosslinking agents, imine type crosslinking agents and the like. The polyfunctional metal chelate is one in which a polyvalent metal is covalently or coordinately bonded to an organic compound. As the polyvalent metal atom, there can be mentioned, for example, Al, Cr, Zr, Co, Cu, Fe, Ni, V, Zn, In, Ca, Mg, Mn, Y, Ce, ST, Ba, Mo, La, Sn, Ti. The covalently or coordinately bonded atom in the organic compound may be an oxygen atom. Examples of the organic compound include alkyl esters, alcohol compounds, carboxylic acid compounds, ether compounds, ketone compounds, and the like.

The amount of the crosslinking agent to be used is preferably 3 parts by weight or less, more preferably from 0.01 to 3 parts by weight, still more preferably from 0.02 to 2 parts by weight, even still more preferably from 0.03 to 1 part by weight, per 100 parts by weight of the (meth)acrylic polymer.

The pressure-sensitive adhesive composition for forming a first pressure-sensitive adhesive layer may contain a silane coupling agent and other additives. For example, polyether compounds of polyalkylene glycol such as polypropylene glycol, powders such as colorants and pigments, dyes, surfactants, plasticizers, tackifiers, surface lubricants, leveling agents, softeners, antioxidants, anti-aging agents, light stabilizers, ultraviolet absorbers, polymerization inhibitors, inorganic or organic fillers, metal powder, particulates, foil-like materials, and the like. In addition, a redox system in which a reducing agent is added may be adopted within a controllable range. These additives are preferably used in an amount of 5 parts by weight or less, more preferably 3 parts by weight or less, still more preferably 1 part by weight or less, with respect to 100 parts by weight of the (meth)acrylic polymer.

### <Anchor Layer>

The anchor layer constituting the in-cell type liquid crystal panel of the present invention is characterized by containing a conductive polymer and having a surface resistance value of from 1.0×10⁸ to 1.0×10¹¹Ω/□. Further, the surface resistance value of the anchor layer is from 1.0×10⁸ to 1.0×10¹¹Ω/□, preferably from 1.0×10⁸ to 5.0×10¹⁰Ω/□, still more preferably from 1.0×10⁸ to 1.0×10¹⁰Ω/□, from the viewpoints of the antistatic function and the touch sensor sensitivity. In particular, since the anchor layer has conductivity (antistatic property), the antistatic function is excellent and it becomes also possible not to use the amount of the antistatic agent used for the pressure-sensitive adhesive layer or possible to reduce the amount of the antistatic agent to a small amount. Therefore, this is a preferable embodiment from the viewpoint of durability and defects of appearance such as precipitation and segregation of the antistatic agent and occurrence of cloudiness in a humidified environment. In addition, in the case where the conduction structure is provided on the side surface of the pressure-sensitive adhesive layer attached first polarizing film that constitutes an in-cell type liquid crystal panel, since the anchor layer has conductivity, it is preferable that a contact area with the conduction structure can be secured as the antistatic layer, resulting in obtaining an excellent antistatic function.

The thickness of the anchor layer is preferably from 0.01 to 0.5 μm, more preferably from 0.01 to 0.4 μm, still more preferably from 0.02 to 0.3 μm from the viewpoints of stability of the surface resistance value, and adhesiveness with the pressure-sensitive adhesive layer, as well as stability of the antistatic function by securing the contact area with the conduction structure.

The conductive polymers are preferably used from the viewpoints of optical properties, appearance, antistatic effect, and stability of antistatic effects during heating or humidification. In particular, conductive polymers such as polyaniline and polythiophene are preferably used. Those which are soluble in an organic solvent or water or are dispersible in water can be appropriately used as a conductive polymer, but a water-soluble conductive polymer or a water-dispersible conductive polymer is preferably used. The water-soluble conductive polymer and the water-dispersible conductive polymer can be prepared as an aqueous solution or an aqueous dispersion of a coating liquid for forming the antistatic layer and the coating liquid does not need to use a nonaqueous organic solvent. Thus, deterioration of the optical film substrate due to the organic solvent can be suppressed. The aqueous solution or aqueous dispersion may contain an aqueous solvent in addition to water. For example, it is possible to use alcohols such as methanol, ethanol, n-propanol, isopropanol, n-butanol, isobutanol, sec-butanol, tert-butanol, n-amyl alcohol, isoamyl alcohol, sec-amyl alcohol, tert-amyl alcohol, 1-ethyl-1-propanol, 2-methyl-1-butanol, n-hexanol, and cyclohexanol.

In addition, it is preferable that the water-soluble conductive polymer or the water-dispersible conductive polymer such as polyaniline and polythiophene has a hydrophilic functional group in the molecule. Examples of the hydrophilic functional group include a sulfone group, an amino group, an amide group, an imino group, a quaternary ammonium salt group, a hydroxyl group, a mercapto group, a hydrazino group, a carboxyl group, a sulfate group, a phosphate group, or salts thereof. By having a hydrophilic functional group in the molecule, the conductive polymer is easily dissolved in water or easily dispersed to microparticles in water, thereby to be able to easily prepare the water-soluble conductive polymer or water-dispersible conductive polymer. In addition, when using a polythiophene-based polymer, a polystyrene sulfonic acid is normally used in combination.

Examples of commercially available water-soluble conductive polymers include polyaniline sulfonic acid (weight average molecular weight in terms of polystyrene: 150,000, manufactured by Mitsubishi Rayon Co., Ltd.) and the like. Examples of commercially available water-dispersible conductive polymers include polythiophene-based conductive polymers (trade name: DENATRON series, manufactured by Nagase ChemteX Corporation) and the like.

As a material for forming the anchor layer, a binder component can be added together with the conductive polymer for the purpose of improving the film forming property of the conductive polymer, the adhesiveness to an optical film, and the like. In the case where the conductive polymer is an aqueous material such as a water-soluble conductive polymer or a water-dispersible conductive polymer, a water-soluble or water-dispersible binder component is used. Examples of the binder include oxazoline group-containing polymers, polyurethane-based resins, polyester-based resins, acrylic resins, polyether-based resins, cellulose-based resins, polyvinyl alcohol-based resins, epoxy resins, polyvinyl pyrrolidone, polystyrene-based resins, polyethylene glycol, pentaerythritol, and the like. In particular, polyurethane-based resins, polyester-based resins and acrylic resins are preferred. One or two or more kinds of these binders can be appropriately used according to the intended application,

The amount of each of the conductive polymer and the binder used is controlled so that the surface resistance value of the obtained anchor layer is in the range of from 10×10⁸ to 1.0×10¹¹Ω/□, although such amount depends on the kind of each of the conductive polymer and the binder.

### <Surface Treatment Layer>

The surface treatment layer can be provided on the side where an anchor layer of the first polarizing film is not provided. The surface treatment layer can be provided on a transparent protective film used for the first polarizing film or provided separately from the transparent protective film. As the surface treatment layer, a hard coat layer, an antiglare treatment layer, an antireflection layer, a sticking prevention layer, and the like can be provided.

The surface treatment layer is preferably a hard coat layer. As a material for forming the hard coat layer, for example, a thermoplastic resin or a material which is cured by heat or radiation can be used. Examples of such materials include thermosetting resins and radiation-curable resins such as ultraviolet curable resins and electron beam curable resins. Among them, ultraviolet curable resins are preferred, which can efficiently form a cured resin layer by a simple processing operation at the time of curing by ultraviolet radiation. Examples of such curable resins include a variety of resins such as polyester-based resins, acrylic resins, urethane-based resins, amide-based resins, silicone-based resins, epoxy-based resins, and melamine-based resins, including monomers, oligomers, and polymers thereof. In particular, radiation curable resins, specifically ultraviolet curable resins are preferred, because of high processing speed and less thermal damage to the base material. The ultraviolet curable resin to be preferably used is, for example, one having an ultraviolet-polymerizable functional group, particularly one containing an acrylic monomer or oligomer component having 2 or more, particularly 3 to 6 of such functional groups. In addition, a photopolymerization initiator is blended in the ultraviolet curable resin.

Further, as the surface treatment layer, an antiglare treatment layer or an antireflection layer can be provided for the purpose of improving visibility. An antiglare layer and an antireflection layer may be provided on the hard coat layer. The constituent material of the antiglare treatment layer is not particularly limited, and for example, a radiation curable resin, a thermosetting resin, a thermoplastic resin, or the like can be used. As the antireflection layer, titanium oxide, zirconium oxide, silicon oxide, magnesium fluoride or the like is used. Multiple layers can be provided for the antireflection layer. Other examples of the surface treatment layer include an anti-sticking layer and the like.

Conductivity can be imparted to the surface treatment layer by incorporating an antistatic agent. As the antistatic agent, those exemplified above can be used.

### <Other Layers>

The pressure-sensitive adhesive layer attached polarizing film of the present invention may be provided with an easy adhesion layer, in addition to each layer described above, on the surface of the first polarizing film at the side where the anchor layer can be provided or various kinds of easy adhesion such as corona treatment and plasma treatment can be applied.

The surface resistance value on a side of the pressure-sensitive adhesive layer of the pressure-sensitive adhesive layer attached polarizing film is preferably controlled to 1.0×10⁸ to 2.0×10¹²Ω/□ Of in order to satisfy the antistatic function of an initial value (room temperature standing condition: 23° C.×65% RH) and after standing under humidification (e.g. 60° C.×95% RH) for 120 hours after) and not to reduce the durability in a humidified or heated environment due to the reduction in the touch sensor sensitivity. The surface resistance value can be adjusted by controlling each surface resistance value of the anchor layer (or the pressure-sensitive adhesive layer or the like). Such surface resistance value is more preferably 1.0×10⁸ to 8.0×10¹⁰Ω/□, still more preferably 2.0×10⁸ to 6.0×10¹⁰Ω/□.

In the in-cell type liquid crystal panel of the present invention, a ratio (b/a) of a variation in a surface resistance values on a side of the first pressure-sensitive adhesive layer is preferably 10 or less, more preferably 5 or less, still more preferably 3 or less. The “a” in the ratio b/a represents a surface resistance value on the side of the first pressure-sensitive adhesive layer when peeling a separator immediately after producing the pressure-sensitive adhesive layer attached first polarizing film in a state where the first polarizing film is provided with the first pressure-sensitive adhesive layer and the first pressure-sensitive adhesive layer is provided with the separator; and

the “b” in the ratio b/a represents a surface resistance value on the side of the first pressure-sensitive adhesive layer when peeling a separator after placing the pressure-sensitive adhesive layer attached polarizing film in a humidified environment of 60° C.×95% RH for 120 hours and further drying the pressure-sensitive adhesive layer attached first polarizing film at 40° C. for 1 hour, respectively. When the ratio (b/a) of the variation exceeds 10; the antistatic function on the side of the pressure-sensitive adhesive layer in a humidified environment is reduced.

### <In-Cell Type Liquid Crystal Cell and In-Cell Type Liquid Crystal Panel>

In-cell type liquid crystal cell B and in-cell type liquid crystal panel C will be described below.

### (In-Cell Type Liquid Crystal Cell B)

As shown in FIGS. 2 to 6, an in-cell type liquid crystal cell B includes a liquid crystal layer 20 containing liquid crystal molecules homogeneously aligned in the absence of an electric field, a first transparent substrate 41 and a second transparent substrate 42 sandwiching the liquid crystal layer 20 on both sides. In addition, a touch sensing electrode unit related to a touch sensor and touch-driven functions is provided between the first transparent substrate 41 and the second transparent substrate 42.

As shown in FIGS. 2, 3, and 6, the touch sensing electrode unit can be formed by a touch sensor electrode 31 and a touch driving electrode 32. The touch sensor electrode referred to herein means a touch detection (reception) electrode. The touch sensor electrode 31 and the touch driving electrode 32 can be independently formed in various patterns. For example, when the in-cell type liquid crystal cell B is a flat surface, it can be disposed in a pattern intersecting at right angles in a form independently provided in the X axis direction and the Y axis direction, respectively. In FIGS. 2, 3, and 6, the touch sensor electrode 31 is disposed on the side (viewing side) of the first transparent substrate 41 with respect to the touch driving electrode 32, but contrary to the above, the touch driving electrode 32 can be disposed on the side of the first transparent substrate 41 (viewing side) with respect to the touch sensor electrode 31.

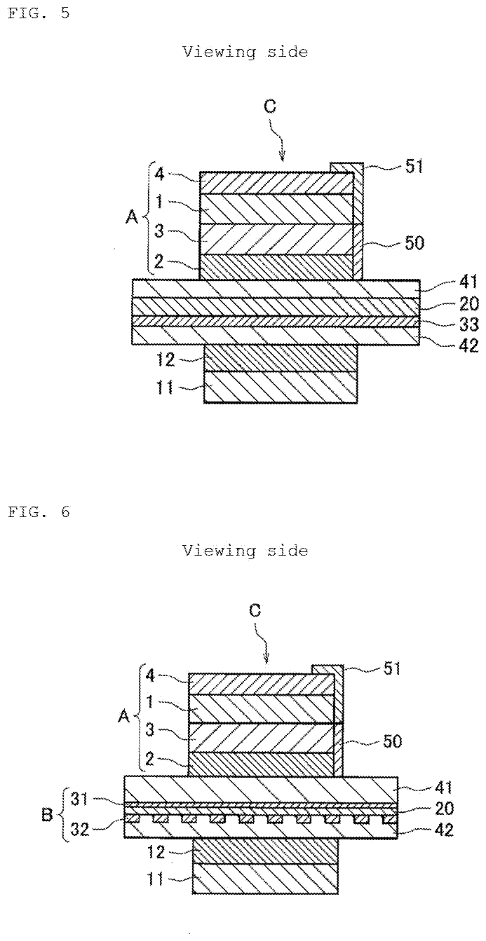

On the other hand, as shown in FIGS. 4 and 5, an electrode 33 in which a touch sensor electrode and a touch driving electrode are integrally formed can be used in the touch sensing electrode unit.

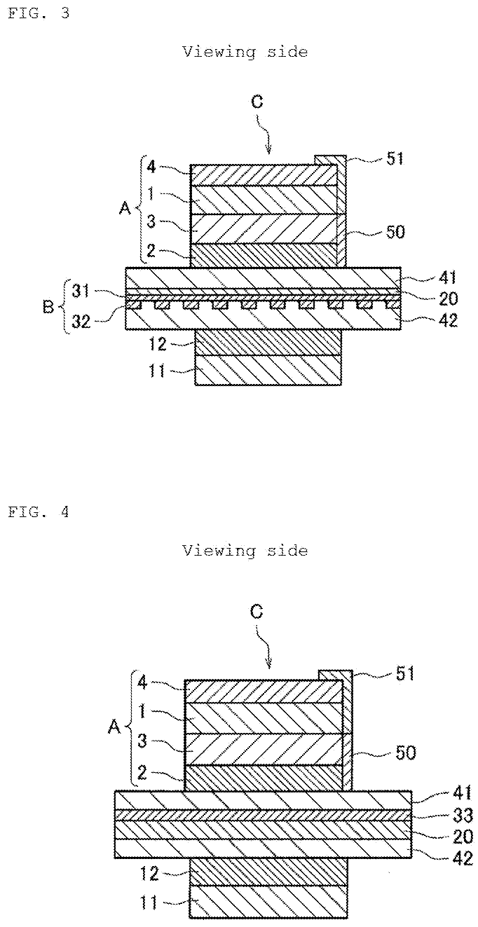

The touch sensing electrode unit may be disposed between the liquid crystal layer 20 and the first transparent substrate 41 or the second transparent substrate 42. Each of FIGS. 2 and 4 shows a case where the touch sensing electrode unit is disposed between the liquid crystal layer 20 and the first transparent substrate 41 (on the viewing side of the liquid crystal layer 20). FIGS. 3 and 5 show a case where the touch sensing electrode unit is disposed between the liquid crystal layer 20 and the second transparent substrate 42 (on the backlight side of the liquid crystal layer 20).

As shown in FIG. 6, the touch sensing electrode unit is able to have the touch sensor electrode 31 between the liquid crystal layer 20 and the first transparent substrate 41, and have the touch driving electrode 32 between the liquid crystal layer 20 and the second transparent substrate 42.

Note that a driving electrode in the touch sensing electrode unit (the touch driving electrode 32, the electrode 33 integrally formed with the touch sensor electrode and the touch driving electrode) can also serve as a common electrode for controlling the liquid crystal layer 20.

As the liquid crystal layer 20 used for the in-cell type liquid crystal cell B, a liquid crystal layer containing liquid crystal molecules homogeneously aligned in the absence of an electric field is used. As the liquid crystal layer 20, for example, an IPS type liquid crystal layer is suitably used. Besides, for the liquid crystal layer 20, for example, any type of liquid crystal layer, such as TN type, STN type, π type, VA type or the like, can be used. The thickness of the liquid crystal layer 20 is, for example, about from 1.5 μm to 4 μm.

As described above, the in-cell type liquid crystal cell B has the touch sensing electrode unit related to the touch sensor and the touch-driven function in the liquid crystal cell and does not have the touch sensor electrode outside the liauid crystal cell. That is, a conductive layer (the surface resistance value is 1×10¹³Ω/□ or less) is not provided on the viewing side (the liquid crystal cell side of the first pressure sensitive adhesive layer 2 of the in-cell type liquid crystal panel C) from the first transparent substrate 41 of the in-cell type liquid crystal cell B. Incidentally, in the in-cell type liquid crystal panel C shown in FIGS. 2 to 6, the order of each configuration is shown, but the in-cell type liquid crystal panel C can have other configurations as appropriate. A color filter substrate can be provided on the liquid crystal cell (the first transparent substrate 41).

Examples of the material for forming the transparent substrate include glass or polymer film. Examples of the polymer film include polyethylene terephthalate, polycycloolefin, polycarbonate, and the like. When the transparent substrate is formed of glass, its thickness is, for example, about from 0.1 mm to 1 mm. When the transparent substrate is formed of a polymer film, its thickness is, for example, about from 10 μm to 200 μm. The transparent substrate may have an easy adhesion layer or a hard coat layer on its surface.

The touch sensing electrode unit is formed as a transparent conductive layer from the touch sensor electrode 31 (electrostatic capacitance sensor) and the touch driving electrode 32, or from the electrode 33 integrally formed with the touch sensor electrode and the touch driving electrode. The constituent material of the transparent conductive layer is not particularly limited, and examples thereof include metals such as gold, silver, copper, platinum, palladium, aluminum, nickel, chromium, titanium, iron, cobalt, tin, magnesium, and tungsten, and alloys thereof. Examples of the constituent material of the transparent conductive layer include metal oxides such as oxides of metals (e.g. indium, tin, zinc, gallium, antimony, zirconium, and cadmium), specifically including indium oxide, tin oxide, titanium oxide, cadmium oxide, and a mixture of these metal oxides. Other metal compounds such as copper iodide and the like are used. The metal oxide may further contain an oxide of the metal atom shown in the above group, if necessary. For example, indium oxide (ITO) containing tin oxide, tin oxide containing antimony, etc. are preferably used, and ITO is particularly preferably used. The ITO preferably contains from 80 to 99% by weight of indium oxide and from 1 to 20% by weight of tin oxide.

The electrode (the touch sensor electrode 31, the touch driving electrode 32, and the electrode 33 formed integrally with the touch sensor electrode and the touch driving electrode) relating to the touch sensing electrode unit can be formed as a transparent electrode pattern usually on the inside of the first transparent substrate 41 and/or the second transparent substrate 42 (on the side of the liquid crystal layer 20 in the in-cell type liquid crystal cell EB by a conventional method. The transparent electrode pattern is usually electrically connected to a lead wiring (not shown) formed at an end portion of the transparent substrate, and the lead wiring is connected to a controller IC (not shown). The shape of the transparent electrode pattern may be any shape such as a stripe shape or a rhombic shape, in addition to a comb shape, depending on the application. The height of the transparent electrode pattern is, for example, from 10 nm to 100 nm and the width is from 0.1 mm to 5 mm.

### (In-Cell Type Liquid Crystal Panel C)

As shown in FIGS. 2 to 6, the in-cell type liquid crystal panel C of the present invention is able to have a pressure-sensitive adhesive layer attached polarizing film A on the viewing side of the in-cell type liquid crystal cell B, and a second polarizing film 11 on the opposite side thereof. The pressure-sensitive adhesive layer attached polarizing film A is disposed on the side of the first transparent substrate 41 of the in-cell type liquid crystal cell B with the first pressure-sensitive adhesive layer 2 interposed therebetween without a conductive layer interposed therebetween. On the other hand, on the side of the second transparent substrate 42 of the in-cell type liquid crystal cell B, the second polarizing film 11 is disposed with the second pressure-sensitive adhesive layer 12 interposed therebetween. The first polarizing film 1 and the second polarizing film 11 in the pressure-sensitive adhesive layer attached polarizing film A are disposed so that the transmission axes (or absorption axes) of the respective polarizers are orthogonal to each other on both sides of the liquid crystal layer 20.

As the second polarizing film 11, those described for the first polarizing film 1 can be used. The second polarizing film 11 to be used may be the same as or different from the first polarizing film 1.

For forming the second pressure-sensitive adhesive layer 12, the pressure-sensitive adhesive described for the first pressure-sensitive adhesive layer 2 can be used. The pressure-sensitive adhesive used for forming the second pressure-sensitive adhesive layer 12 may be the same as or different from the first pressure-sensitive adhesive layer 2. The thickness of the second pressure-sensitive adhesive layer 12 is not particularly limited, and is, for example, approximately from 1 to 100 μm, preferably from 2 to 50 μm, more preferably from 2 to 40 μm, and still more preferably from 5 to 35 μm.

In an in-cell type liquid crystal panel C, a conduction structure 50 can be provided on the side surfaces of the anchor layer 3 and the first pressure-sensitive adhesive layer 2 of the pressure-sensitive adhesive layer attached polarizing f ilm A. The conduction structure 50 may be provided on the entire side surface of the anchor layer 3 and the first pressure-sensitive adhesive layer 2 or may be provided on a part thereof. In the case where the conduction structure is provided in part, it is preferable that the conduction structures is provided in a proportion of preferably 1 area % or more, more preferably 3 area % or more, of the area of the side surface in order to ensure conduction on the side surface. In addition to the above, as shown in FIG. 2, the conductive material 51 can be provided on the side surface of the first polarizing film 1.

It is possible to suppress the occurrence of static electricity by connecting an electric potential to the other suitable portion from the side surface of the anchor layer 3 and the first pressure-sensitive adhesive layer 2 by the conduction structure 50. As a material for forming the conduction structures 50 and 51, for example, a conductive paste such as silver paste, gold paste or other metal paste can be mentioned, and other conductive adhesives or any other suitable conductive materials can be used. The conduction structure 50 can be formed, for example, in a linear shape extending from the side surface of the anchor layer 3 and the first pressure-sensitive adhesive layer 2. The conduction structure 51 can also be formed in the same linear shape.

In addition, the first polarizing film 1 disposed on the viewing side of the liquid crystal layer 20, and the second polarizing film 11 disposed on the side opposite to the viewing side of the liquid crystal layer 20 can be used by laminating other optical films, depending on the suitability of each arrangement position. As the other optical film which may be used for forming a liquid crystal display device or the like, there are exemplified those capable of forming an optical film layer, such as a reflector, an anti-transmission plate, a retardation film (including wavelength plates such as ½ and ¼), a visual compensation film, and a brightness enhancement film. These can be used in one layer or in two or more layers.

### (Liquid Crystal Display Device)

The liquid crystal display device using the in-cell type liquid crystal panel (liquid crystal display device with a built-in touch sensing function) of the present invention can use appropriately members which form a liquid crystal display device, such as those using a backlight or reflector for lighting system.

### EXAMPLES

Hereinafter, the present invention will be specifically described by way of Production Examples and Examples, but the present invention is not limited by these Examples. All parts and % in each Example are based on weight. The following “initial value” (room temperature standing condition) is a value in a state left standing at 23° C.×65% RH and the value “after humidification” refers to a value measured after charging in a humidified environment of 60° C.×95% RH for 120 hours and further drying at 40° C. for 1 hour.

### <Measurement of Weight Average Molecular Weight of (Meth)Acrylic Polymer>

The weight average molecular weight (Mw) of a (meth)acrylic polymer was measured by GPC (gel permeation chromatography). The molecular weight distribution (Mw/Mn) was also measured in the same manner.
Analyzer: HLC-8120 GPC, manufactured by Tosoh Corporation
Column: G7000H_{XL}+GMH_{XL}+GMH_{XL}, manufactured by Tosoh Corporation
Column size: 7.8 mmφ×30 cm each in total 90 cm
Column temperature: 40° C.
Flow rate: 0.8 mL/min
Injection volume: 100 μL
Eluent: Tetrahydrofuran
Detector: Differential refractometer (RI)
Standard sample: Polystyrene

(Preparation of Polarizing Film)

An 80-μm thick polyvinyl alcohol film was stretched up to 3 times while being stained for 1 minute in a 0.3% iodine solution at 30° C. between rolls with different speed ratios. Thereafter, the film was stretched to a total stretching ratio of 6 times while being immersed in an aqueous solution containing 4% boric acid and 10% potassium iodide at 60° C. for 0.5 minutes. Subsequently, after washing the film by immersing in an aqueous solution containing 3.5% potassium iodide at 30° C. for 10 seconds, drying was performed at 50° C. for 4 minutes to obtain a 20 μm-thick polarizer. Each transparent protective film described below was bonded on both sides of the polarizer, with a polyvinyl alcohol-based adhesive, thereby to produce polarizing films P1 and P2.

In addition, a kind of polarizing film (polarizing plate) in Table 1 was produced using a transparent protective film having the following moisture permeability.

P1: Cycloolefin polymer (COP)-based polarizing film: A 13 μm-thick COP-based transparent protective film (moisture permeability: 36 g/(m²·24 h), manufactured by Zeon Corporation) was used after being subjected to corona treatment.

P2: TAC-based polarizing film: A 25-μm TAO-based transparent protective film (moisture permeability: 1000 g/(m²·24 h), manufactured by Fujifilm Corporation) was used after being subjected to a saponification treatment.

Corona treatment (0.1 kw, 3 m/min, 300 mm width) as an easy adhesion treatment was carried out on the anchor layer forming surface side of the polarizing film.

### (Preparation of Forming Material of Anchor Layer)

A solution (8.6 parts) containing, as a solid content, 30 to 90% by weight of an urethane-based polymer and 10 to 50% by weight of a thiophene-based polymer (trade name: DENATRON P-580W, manufactured by Nagase ChemteX Corporation), 1 part of a solution containing 10 to 70% by weight of an oxazoline group-containing acrylic polymer and 10 to 70% by weight of polyoxyethylene group-containing methacrylate (trade name: EPOCROS WS-700, manufactured by Nippon Shokubai Co., Ltd.), and 90.4 parts of water were mixed to prepare a coating solution having a solid content concentration of 0.5% by weight for forming an anchor layer.

### (Formation of Anchor Layer)

The coating solution for forming an anchor layer was applied to one side of the polarizing film such that the thickness after drying becomes the thickness shown in Table 1, and dried at 80° C. for 2 minutes to form an anchor layer.

### (Preparation of Acrylic Polymer)

A monomer mixture containing 75 parts of butyl acrylate (BA), 21 parts of phenoxyethyl acrylate (PEA), 3.3 parts of N-vinylpyrrolidone (NVP), 0.3 parts of acrylic acid (AA) and 0.4 parts of 4-hydroxybutyl acrylate (HBA) was charged into a four-necked flask equipped with a stirring blade, a thermometer, a nitrogen gas inlet tube and a condenser. To 100 parts (solid content) of the monomer mixture, 0.1 parts of 2,2-azobisisobutyronitrile as a polymerization initiator were charged together with 100 parts of ethyl acetate, and nitrogen gas was introduced thereto with gentle stirring. After purging the inside of the flask with nitrogen gas, a polymerization reaction was carried out for 8 hours while keeping the liquid temperature in the flask at around 55° C. to prepare a solution of an acrylic polymer having a weight average molecular weight (Mw) of 1,600,000 and a ratio Mw/Mn of 3.6.

### (Preparation of Pressure-Sensitive Adhesive Composition)

An ionic compound in an amount (solid content, active ingredient) shown in Table 1 was blended with 100 parts (solid content) of the acrylic polymer solution obtained above, and 0.1 parts of an isocyanate crosslinking agent (TAKENATE D160N, trimethylopropane hexamethylene diisocyanate, manufactured by Mitsui Chemicals, Inc.), 0.3 parts of benzoyl peroxide (NYPER BMT, manufactured by NOF Corporation), and 0.3 parts of a silane coupling agent (X-41-1810, manufactured by Shin-Etsu Chemical Co., Ltd.) were added thereto to prepare a solution of an acrylic pressure-sensitive adhesive composition used in each of Examples and Comparative Examples.

Abbreviations of the ionic compounds described in Table 1 are as follows.

Li-TFSI: Lithium bis(trifluoromethanesulfonyl)imide, an alkali metal salt (an inorganic cation-anion salt), manufactured by Mitsubishi Materials Corporation.

MPP-TFSI: Methyl propyl pyrrolidinium bis(trifluoromethanesulfonyl)imide, an ionic liquid (an organic cation-anion salt), manufactured by Mitsubishi Materials Corporation.

EMI-TFSI: 1-Ethyl-3-methylimidazoium bis(trifluoromethanesulfonyl)imide, an ionic liquid (an organic cation-anion salt), manufactured by Daiichi Kogyo Seiyaku Co., Ltd.

EMI-FSI: 1-Ethyl-3-methylimidazolium bis(fluorosulfonyl imide, an ionic liquid (an organic cation-anion salt), manufactured by Daiichi Kogyo Seiyaku Co., Ltd.

TBMA-TFSI: Tributylmethylammonium bis(trifluoromethanesulfonyl)imide, an ionic liquid (an organic cation-anion salt), manufactured by Mitsubishi Materials Corporation.

### (Formation of Pressure-Sensitive Adhesive Layer)

Next, the acrylic pressure-sensitive adhesive composition solution was applied onto one side of a polyethylene terephthalate (PET) film (separator film: MRF 38, manufactured by Mitsubishi Polyester Film Corp.) treated with a silicone-based release agent, in such a manner that the pressure-sensitive adhesive layer after drying has a thickness of 23 μm, and dried at 155° C. for 1 minute to form a pressure-sensitive adhesive layer on the surface of the separator film. The pressure-sensitive adhesive layer was transferred to a polarizing film on which an anchor layer was formed.

### <Examples 1 to 6, Comparative Examples 1 to 4, and Reference Example 1

By the combination shown in Table 1, an anchor layer and a pressure-sensitive adhesive layer were sequentially formed on one side (corona-treated side) of the polarizing film obtained above to produce a pressure-sensitive adhesive layer attached polarizing film.

In Comparative Examples 1 to 3, the pressure-sensitive adhesive layer attached polarizing film not including the anchor layer was used, and in Comparative Example 4, the pressure-sensitive adhesive layer attached polarizing film having a surface resistance value of the anchor layer outside the desired range (1.0×10⁸ to 1.0×10¹¹Ω/□) was used.

The following evaluations were performed about the anchor layer, the pressure-sensitive adhesive layer, and the pressure-sensitive adhesive layer attached polarizing film which were obtained in the above Examples and Comparative Examples. The evaluation results are shown in Table 1 and Table 2.

### <Moisture Permeability of Transparent Protective Film>

Moisture permeability of the transparent protective film was measured according to the moisture permeability test (cup method) of JIS Z0208. A transparent protective film cut into a diameter of 60 mm was set in a moisture-permeable cup containing about 15 g of calcium chloride, placed in a thermostatic chamber of 40° C. and 92% RI, and allowed to stand for 24 hours, after which time the moisture permeability (g/(m²·24 h)) was determined by measuring an increase in weight of calcium chloride.

### <Surface Resistance Value (Ω/□): Conductivity>

(i) The surface resistance value of the anchor layer was measured on the anchor layer side surface of the anchor layer attached polarizing film before forming the pressure-sensitive adhesive layer (see Table 1).

(ii) The surface resistance value of the pressure-sensitive adhesive layer was measured on the surface of the pressure-sensitive adhesive layer formed on the separator film (see Table 1).

(iii) The surface resistance value on a side of the pressure-sensitive adhesive layer was obtained by peeling the separator film from the obtained pressure-sensitive adhesive layer attached polarizing film, and then measuring the surface resistance value on the surface of the pressure-sensitive adhesive layer (see Table 2).

The measurement was made using a device MCP-HT450 manufactured by Mitsubishi Chemical Analytech Co., Ltd. The surface resistance value (i) is a value after measurement for 10 seconds at an applied voltage of 10 V. The surface resistance values (ii) and (iii) are values after measurement for 10 seconds at an applied voltage of 250V

The ratio (b/a) of the variation in Table 2 is a value calculated from the surface resistance value (a) of “initial value” and the surface resistance value (b) of “after humidification” (a value rounded to one decimal place).

### <ESD Test>

In Examples 1 to 6 and Comparative Examples 1 to 4, a separator film was peeled off from the pressure-sensitive adhesive layer attached polarizing film and then the polarizing film was bonded to the viewing side of the in-cell type liquid crystal cell as shown in FIG. 3.

Next, a silver paste having a width of 10 mm was applied to the side surface portion of the bonded polarizing film so as to cover each side surface portion of the polarizing film, the anchor layer, and the pressure-sensitive adhesive layer and connected to a ground electrode from the outside.

In Reference Examples 1, the separator film was peeled off from the pressure-sensitive adhesive layer attached polarizing film and then the polarizing film was bonded to the viewing side (sensor layer) of an on-cell liquid crystal cell.

The liquid crystal display device panel was set on a backlight device, and an electrostatic discharge gun was shot onto the polarizing film surface on the viewing side at an applied voltage of 9 kV, and the period until disappearance of white voids due to electricity was measured, and this was judged as “initial value” according to the following criteria. Regarding the value “after humidification”, as well as “initial value”, judgment was made according to the following criteria. The evaluation result causing a problem in practical use is indicated as x.

### (Evaluation Criteria)

⊙: The period until disappearance of white voids due to electricity is within 3 seconds.

∘: The period until disappearance of white voids due to electricity is more than 3 seconds and within 10 seconds.

Δ: The period until disappearance of white voids due to electricity is more than 10 seconds and within 60 seconds.

x: The period until disappearance of white voids due to electricity is more than 60 seconds.

### <TSP Sensitivity>

In Examples 1 to 6 and Comparative Examples 1 to 4, a lead wiring (not shown) at the peripheral portion of a transparent electrode pattern inside an in-cell type liquid crystal cell was connected to a controller IC (not shown), and in Reference Examples 1, a lead wiring at the peripheral portion of a transparent electrode pattern on an on-cell liquid crystal cell viewing side was connected to a controller IC, thereby to fabricate a liquid crystal display device with a built-in touch sensing function. In a state where the input display device of the liquid crystal display device with a built-in touch sensing function is used, visual observation was carried out and the presence or absence of malfunction was confirmed using this “initial value”.

∘: No malfunction occurred

x: Malfunction occurred

### <Heating Durability>

A pressure-sensitive adhesive layer attached polarizing film cut into a 15-inch size was used as a sample. The sample was stuck to a 0.7 mm-thick alkali-free glass (EG-XG, manufactured by Corning Incorporated) using a laminator.

Subsequently, the sample was autoclaved at 50° C. under a pressure of 0.5 MPa for 15 minutes to completely adhere to the alkali-free glass. The sample subjected to such treatment was treated for 500 hours in an atmosphere of 80° C. or 90° C. and then the appearance between the polarizing film and the alkali-free glass was visually evaluated according to the following criteria. In addition, the evaluation result causing a problem in practical use is indicated by x.

### (Evaluation Criteria)

∘: There is no change in appearance such as foaming and peeling.

Δ: Slight peeling or foaming occurs at the end portion of the sample, causing no problem in practical use.

x: Significant peeling occurs at the end portion of the sample, causing a problem in practical use.

TABLE 1

| | | | | | | | | | Surface | |
|---|---|---|---|---|---|---|---|---|---|---|
| | | | | | | | Ionic compound | | resistance | Surface |
| | | | | | | | (B) | | value of | resistance |
| | | | | | | | | Blending | pressure- | value of |
| | | | | | | | | amount | sensitive | conductive |
| | Kind of | | | | | | | (parts | adhesive | anchor layer |
| | polarizing | | | | | | | by | layer alone | alone |
| | film | BA | PEA | NVP | HBA | AA | Kind | weight) | (Ω/□) | (Ω/□) |
| Example 1 | P1 | 75 | 21 | 3.3 | 0.4 | 0.3 | Li-TFSI | 0.5 | 1.3.E+11 | 2.4.E+08 |
| Example 2 | P1 | 75 | 21 | 3.3 | 0.4 | 0.3 | EMI-FSI | 8 | 8.3.E+08 | 2.4.E+08 |
| Example 3 | P1 | 75 | 21 | 3.3 | 0.4 | 0.3 | TBMA-TFSI | 1 | 2.0.E+11 | 2.4.E+08 |
| Example 4 | P2 | 75 | 21 | 3.3 | 0.4 | 0.3 | Li-TFSI | 0.5 | 1.3.E+11 | 1.1.E+08 |
| Example 5 | P2 | 75 | 21 | 3.3 | 0.4 | 0.3 | EMI-FSI | 8 | 8.3.E+08 | 1.1.E+08 |
| Example 6 | P2 | 75 | 21 | 3.3 | 0.4 | 0.3 | TBMA-TFSI | 1 | 2.0.E+11 | 1.1.E+08 |
| Comparative | P2 | 75 | 21 | 3.3 | 0.4 | 0.3 | MPP-TFSI | 7 | 5.5.E+09 | — |
| Example 1 | | | | | | | | | | |
| Comparative | P2 | 75 | 21 | 3.3 | 0.4 | 0.3 | EMI-TFSI | 7 | 3.2.E+09 | — |
| Example 2 | | | | | | | | | | |
| Comparative | P2 | 75 | 21 | 3.3 | 0.4 | 0.3 | EMI-FSI | 7 | 1.0.E+09 | — |
| Example 3 | | | | | | | | | | |
| Comparative | P1 | 75 | 21 | 3.3 | 0.4 | 0.3 | — | — | — | 1.1.E+12 |
| Example 4 | | | | | | | | | | |
| Reference | P1 | 75 | 21 | 3.3 | 0.4 | 0.3 | — | — | — | 2.3.E+09 |
| Example 1 | | | | | | | | | | |

TABLE 2

| | | Surface resistance value | | | | | | | |
|---|---|---|---|---|---|---|---|---|---|
| | | of pressure-sensitive | | | | | | | |
| | | adhesuve layer side | | | | | | | |
| | | (Ω/□) | | | | | | | |
| | | | After | | | ESD evaluation | | | |
| | | | humidification | | | | After | Heating | Heating |
| | | | under | | | | humidification | durability | durability |
| | | | 60° C., | Ratio | | | under | under | under |
| | Kind of | | 9.5% RH, | of | TSP | | 60° C., | 80° C., | 90° C., |
| | evaluation | Initial | 120 hours | variation | sensitibity | | 9.5% RH, | 500 | 500 |
| | panel | (a) | (b) | (b/a) | malfunction | Initial | 120 hours | hours | hours |
| Example 1 | In-cell | 4.0.E+09 | 7.4.E+09 | 1.9 | ◯ | ⊙ | ⊙ | ◯ | Δ |
| Example 2 | In-cell | 8.5.E+08 | 8.9.E+08 | 1.0 | ◯ | ⊙ | ⊙ | ◯ | Δ |
| Example 3 | In-cell | 2.8.E+09 | 5.2.E+09 | 1.9 | ◯ | ⊙ | ⊙ | ◯ | Δ |
| Example 4 | In-cell | 3.4.E+09 | 8.0.E+09 | 2.4 | ◯ | ⊙ | ⊙ | ◯ | ◯ |
| Example 5 | In-cell | 8.4.E+08 | 8.9.E+08 | 1.1 | ◯ | ⊙ | ⊙ | ◯ | ◯ |
| Example 6 | In-cell | 2.0.E+09 | 5.7.E+09 | 2.9 | ◯ | ⊙ | ⊙ | ◯ | ◯ |
| Comparative | In-cell | 5.5.E+09 | 2.2.E+11 | 40.4 | ◯ | ◯ | X | ◯ | ◯ |
| Example 1 | | | | | | | | | |
| Comparative | In-cell | 3.2.E+09 | 2.3.E+11 | 71.6 | ◯ | ◯ | X | ◯ | ◯ |
| Example 2 | | | | | | | | | |
| Comparative | In-cell | 1.0.E+09 | 1.9.E+11 | 187.2 | ◯ | ⊙ | X | ◯ | ◯ |
| Example 3 | | | | | | | | | |
| Comparative | In-cell | 2.8.E+12 | 4.5.E+12 | 1.6 | ◯ | X | X | ◯ | Δ |
| Example 4 | | | | | | | | | |
| Reference | On-cell | 2.6.E+09 | 3.5.E+09 | 1.3 | X | ⊙ | ⊙ | ◯ | Δ |
| Example 1 | | | | | | | | | |

From the evaluation results of Table 2 above, it was confirmed that the heating durability, the antistatic property, the suppression of electrostatic unevenness, and the touch sensor sensitivity were at practical levels in all the Examples. In particular, when using a polarizing film (P2) having a moisture permeability of the transparent protective film in the range of 800 to 1200 g/(m²·24 h), good results were obtained even in a heating durability test at a high heat of 90° C. On the other hand, in Comparative Examples 1 to 3, since the pressure-sensitive adhesive layer attached polarizing film not comprising an anchor layer having conductivity (antistatic property) was used, it was confirmed that the variation of the surface resistance values in a humidified environment was large beyond the preferable range of the surface resistance value, and it took time for void area made into white voids to disappear. Moreover, in Comparative Example 4, although an anchor layer was provided, an anchor layer which does not have a desired surface resistance value was used and thus it was confirmed that it took time for void area made into white voids to disappear. In Reference Example 1, when applied to an on-cell liquid crystal cell, a decrease in touch sensor sensitivity was confirmed.

### DESCRIPTION OF REFERENCE SIGNS

A Pressure-sensitive adhesive layer attached polarizing film
B In-cell type liquid crystal cell
C In-cell type liquid crystal panel
1, 11 First and second polarizing films
2, 12 First and second pressure-sensitive adhesive layers
3 Anchor layer
4 Surface treatment layer
20 Liquid crystal layer
31 Touch sensor electrode
32 Touch driving electrode
33 Touch driving electrode and sensor electrode
41, 42 First and second transparent substrates

1. A pressure-sensitive adhesive layer attached polarizing film comprising a pressure-sensitive adhesive layer and a polarizing film, wherein:
the polarizing film comprises at least a polarizer and a transparent protective film,
at least the polarizing film, an anchor layer, and the pressure-sensitive adhesive layer are provided in this order from a viewing side,
the anchor layer includes a conductive polymer,
a surface resistance value of the anchor layer is from 1.0×10⁸ to 1.0×10¹¹Ω/□, and
a moisture permeability of the transparent protective film at 40° C.×92% RH is 10 g/(m²·24 h) or more.

2. The pressure-sensitive adhesive layer attached polarizing film according to claim 1, wherein a surface resistance value on a side of the pressure-sensitive adhesive layer when peeling a separator immediately after producing the pressure-sensitive adhesive layer attached polarizing film in a state where the pressure-sensitive adhesive layer is provided with the separator is from 1.0×10⁸ to 2.0×10¹²Ω/□

3. The pressure-sensitive adhesive layer attached polarizing film according to claim 1, wherein the pressure-sensitive adhesive layer includes an antistatic agent and has a surface resistance value of from 1.0×10⁸ to 5.0×10¹¹Ω/□.

4. A pressure-sensitive adhesive layer attached polarizing film for an in-cell type liquid crystal panel, which comprises an in-cell type liquid crystal cell that is provided with a liquid crystal layer comprising liquid crystal molecules which are homogeneously aligned in the absence of an electric field, a first transparent substrate and a second transparent substrate sandwiching the liquid crystal layer on both sides, and a touch sensing electrode unit related to a touch sensor and touch-driven functions disposed between the first transparent substrate and the second transparent substrate, and which is disposed on a viewing side of the in-cell type liquid crystal cell, wherein:
the pressure-sensitive adhesive layer of the pressure-sensitive adhesive layer attached polarizing film is disposed between the polarizing film of the pressure-sensitive adhesive layer attached polarizing film and the in-cell type liquid crystal cell,
the polarizing film comprises at least a polarizer and a transparent protective film,
at least the polarizing film, an anchor layer, and the pressure-sensitive adhesive layer are provided in this order from the viewing side,
the anchor layer includes a conductive polymer,
a surface resistance value of the anchor layer is from 1.0×10⁸ to 1.0×10¹¹Ω/□, and
a moisture permeability of the transparent protective film at 40° C.×92% RH is 10 g/(m²·24 h) or more.

5. The pressure-sensitive adhesive layer attached polarizing film for an in-cell type liquid crystal panel according to claim 4, wherein a surface resistance value on a side of the pressure-sensitive adhesive layer is from 1.0×10⁸ to 2.0×10¹²Ω/□ when peeling a separator immediately after producing the pressure-sensitive adhesive layer attached polarizing film in a state where the pressure-sensitive adhesive layer is provided with the separator.

6. The pressure-sensitive adhesive layer attached polarizing film for an in-cell type liquid crystal panel according to claim 4, wherein the pressure-sensitive adhesive layer includes an antistatic agent and has a surface resistance value of from 1.0×10⁸ to 5.0×10¹¹Ω/□.

7. An in-cell type liquid crystal panel comprising:
an in-cell type liquid crystal cell comprising a liquid crystal layer containing liquid crystal molecules which are homogeneously aligned in the absence of an electric field, a first transparent substrate and a second transparent substrate sandwiching the liquid crystal layer on both sides, and a touch sensing electrode unit related to a touch sensor and touch-driven functions disposed between the first transparent substrate and the second transparent substrate; and
a first polarizing film disposed on a viewing side of the in-cell type liquid crystal cell, a second polarizing film disposed on an opposite side of the viewing side, and a first pressure-sensitive adhesive layer disposed between the first polarizing film and the in-cell type liquid crystal cell; wherein:
the first polarizing film comprises at least a polarizer and a transparent protective film,
at least the first polarizing film, an anchor layer, and the first pressure-sensitive adhesive layer are provided in this order from the viewing side,
the anchor layer includes a conductive polymer,
a surface resistance value of the anchor layer is from 1.0×10⁸ to 1.0×10¹¹Ω/□, and
a moisture permeability of the transparent protective film at 40° C.×92% RH is 10 g/(m²·24 h) or more.

8. The in-cell type liquid crystal panel according to claim 7, wherein a surface resistance value on a side of the pressure-sensitive adhesive layer when peeling a separator immediately after producing the pressure-sensitive adhesive layer attached first polarizing film in a state where the first pressure-sensitive adhesive layer is provided with the separator is from 1.0×10⁸ to 2.0×10¹²Ω/□.

9. The in-cell type liquid crystal panel according to claim 7,
wherein the first pressure-sensitive adhesive layer includes an antistatic agent and has a surface resistance value of from 1.0×10⁸ to 5.0×10¹¹Ω/□.

10. A liquid crystal display device comprising the in-cell type liquid crystal panel according to claim 7.
